(19) United States
(12) Patent Application Publication
(10) Pub. No.: US 2024/0342969 A1
(43) Pub. Date: Oct. 17, 2024

(54) METHOD OF PRODUCING A COVER FOR A VEHICLE ROOF

(71) Applicant: Webasto SE, Stockdorf (DE)

(72) Inventor: Robert KOCH, Stockdorf (DE)

(21) Appl. No.: 18/292,649

(22) PCT Filed: Jul. 22, 2022
(86) PCT No.: PCT/EP2022/070658

§ 371 Date: Jan. 26, 2024

(30) Foreign Application Priority Data
Aug. 17, 2021 (DE) 10 2021 121 368.1

(51) Int. Cl. B29C 45/14; B29L 31/30

(52) U.S. Cl. CPC B29C 45/14377; B29C 45/14418; B29C 45/14434; B29C 2045/14868; B29L 2031/30

(57) ABSTRACT

A method of producing a cover for optionally opening or tightly closing an opening in a vehicle roof, the cover having a sheet and a peripheral overmolding. According to the method, a coating is applied in a region which is later visible and which is to be covered, to a portion on the transparent sheet adjacent to the peripheral overmolding to be applied, and the coating is removed once the peripheral overmolding has been applied.

### CROSS-REFERENCE TO RELATED APPLICATIONS

This application is a U.S. national phase application filed under 35 U.S.C. § 371 of International Application No. PCT/EP2022/070658, filed on Jul. 22, 2022, published under WO 2023/020781A1 on Feb. 23, 2023, designating the United States, which claims priority from German Patent Application Number 10 2021 121 368.1, filed on Aug. 17, 2021, which are hereby incorporated herein by reference in their entirety.

### FIELD

The present invention relates to a method of producing a cover for elective opening or firm closing of an opening in a vehicle roof. A cover of this generic type has a transparent sheet and a foam edging.

### BACKGROUND

In known methods of producing such a cover, the foam edging is foamed by creating a metallic hard seal of the transparent sheet in a mold against a mold base by pressing, in order then to inject a foam material, for example a polyurethane, into a cavity by a foaming process.

A disadvantage of such known methods is the fact that no uniformly circumferential flush seal is achieved. As a result, foam material can get onto the surface of the transparent sheet. The material driven out as a result has to be removed again mechanically in subsequent operations. This results in drawbacks in terms of the quality of the product and, moreover, the reworking process is time-consuming and costly.

### SUMMARY

It is therefore an object of the present invention to provide a method of producing such a cover, in which the problems mentioned above are avoided.

This object is achieved by a production method according to claim 1.

In a method of the invention, a coating is applied in the course of the method atop a region to be covered on the transparent sheet that is to be visible at a later stage, adjacent to the foam edging to be foamed.

The transparent sheet is then introduced into an open mold such that an edge region of the sheet is disposed in a cavity of the mold for formation of foam edging on the sheet.

Subsequently, the mold is closed, and a polymer or polymer foam is injected into the cavity in order to form the foam edging of the cover.

The mold is then opened again and the cover is removed from the mold. Subsequently, the coating is removed again, for example pulled off.

Such a method of the invention offers the advantage that the coating protects regions on the sheet that will be visible later from contamination and especially from foam material that escapes from the cavity in an unwanted manner. The coating applied improves sealing between the transparent sheet and the mold in the closed state of the mold with respect to the adjacent cavity. A uniform circumferential seal can thus be achieved and prevents foam material from escaping from the cavity onto the surface of the transparent sheet. All that remains to be done after the foaming process is to pull the coating away from the transparent sheet. A considerable cost benefit is thus generated, and a distinct improvement in quality is achieved.

Advantageous configurations of the present invention will be apparent from the subsidiary claims.

The coating preferably forms a sealing section. It is especially advantageous here when the coating, with the mold closed, seals a lower portion of the mold with respect to the transparent sheet and, further preferably, with the mold closed, seals the lower portion of the mold and the transparent sheet with respect to the cavity. What this advantageously achieves is that, when the mold is closed, the sealing effect in such a sealing section between the mold and the transparent sheet is improved considerably compared to known methods without such a coating.

Especially when a glass sheet is used as transparent sheet, it is advantageously possible to select the material for the coating such that it is firstly elastic enough to form the appropriate sealing effect and secondly can be easily removed again from the glass sheet after the foaming process.

In a further preferred method of the invention, the transparent sheet is formed by such a glass sheet, such that the method of the invention here imparts the advantages detailed above to a particular degree by virtue of the application of a separate coating to the glass sheet.

Advantageously, the foam edging is formed from a polyurethane foam and, further advantageously, the coating is applied by applying a liquid polymer, which then forms the coating after a drying process, to the region to be covered before the transparent sheet is introduced into the mold.

Preferably, the liquid polymer is solidified and/or dried after the application to the region to be covered and before the transparent sheet is introduced into the mold. This avoids entraining of liquid polymer via the transparent sheet as a result of the handling process of introducing the transparent sheet into the mold, or coverage of the mold by liquid polymer at unintended sites, which then has an adverse effect on the foaming process.

Alternatively, the coating can be applied by applying, preferably sticking, a solid polymer film or a foil onto the region to be covered before the transparent sheet is introduced into the mold. It is possible here to use a self-adhesive material or a material having a previously applied adhesive film.

In a further preferred configuration of the present method, an elastic material is used for the coating, further preferably an adhesive tape, especially a polyester adhesive tape. An elastic material is understood here to mean a material having a modulus of elasticity in GPa at 20° C. of 0.05 to 5, i.e. between the typical moduli of elasticity of unvulcanized rubber and hard rubber. The preferred material (for example a polyester adhesive tape) has an elongation at break of 80% to 100%, preferably of 93% to 97%. Elongation at break here is the change in length that remains after fracture, relative to the length of a sample as measured at the start of the tensile test. A corresponding adhesive tape preferably has a thickness of less than 0.04 mm.

The use of such an elastic material gives a particularly good sealing effect between the mold, which preferably consists of a metal, and the transparent sheet. Especially when a glass sheet is used as transparent sheet, the sealing effect between glass sheet and the metal surface of the mold is particularly improved.

In a further preferred method of the invention, the mold has an upper portion of the mold, a lower portion of the mold and a lateral portion of the mold. The upper portion of the mold and lower portion of the mold can thus accommodate the transparent sheet for the foaming process, and the foam edging can be foamed at an outer edge of the sheet by means of the cavity, which are bounded at least partly by the upper portion of the mold and lower portion of the mold.

The lateral portion of the mold bounds the cavity at an outer edge of the foam edging. The main function of such a lateral portion of the mold is to form a groove for mounting of a seal on the cover, wherein the groove is formed by the foam edging after the foaming process. In this advantageous configuration of the method of the invention, there is a projection disposed for the purpose on the lateral portion of the mold, which extends into the cavity in order thus to form the groove. As a result of the providing of a lateral portion of the mold, it is advantageously possible to provide a groove having an undercut in order to improve the mounting of a seal to be applied later on the cover. The lateral portion of the mold with the projection may advantageously take the form of a slider, in order to be able to part the cover with edge foaming from the mold. It is also possible to provide for forced demolding, where the cover with edge foaming is removed from the lateral portion of the mold with elastic deformation of the foam edging. The groove is thus parted from the projection.

In a further preferred method of the invention, the coating is disposed on one side of the transparent sheet which, in the installed state of the cover on a vehicle roof, constitutes a top face of the cover. This is a particularly critical region since this top face of the cover and hence the top face of the transparent sheet of the cover have very good visibility when the vehicle is viewed from the outside, and residues of foam material in these regions would greatly impair the visual impression.

Particular preference is further given to a method of the invention in which the foam edging extends from one edge of the transparent sheet as far as the opposite side of the transparent sheet from the coating. This means that the foam edging in the installed state of the cover runs a little further from the edge of the cover on an underside of the transparent sheet toward the middle of the cover, while the coating in the foaming process extends on the opposite side of this horizontal section of the foam edging. The foam edging thus covers an outer edge of the transparent sheet and, from this point, forms a horizontal section on the opposite side of the transparent sheet from the coating. It is thus advantageously possible for the foam edging to be bonded particularly well to the transparent sheet.

### BRIEF DESCRIPTIONS OF THE DRAWINGS

There follows a detailed elucidation of the invention by way of example with reference to the appended FIGURE.

The FIGURE shows:

FIG. 1 a cross section through a mold in an edge region of a cover to be subjected to overmolding, employing the method of the invention.

### DETAILED DESCRIPTION

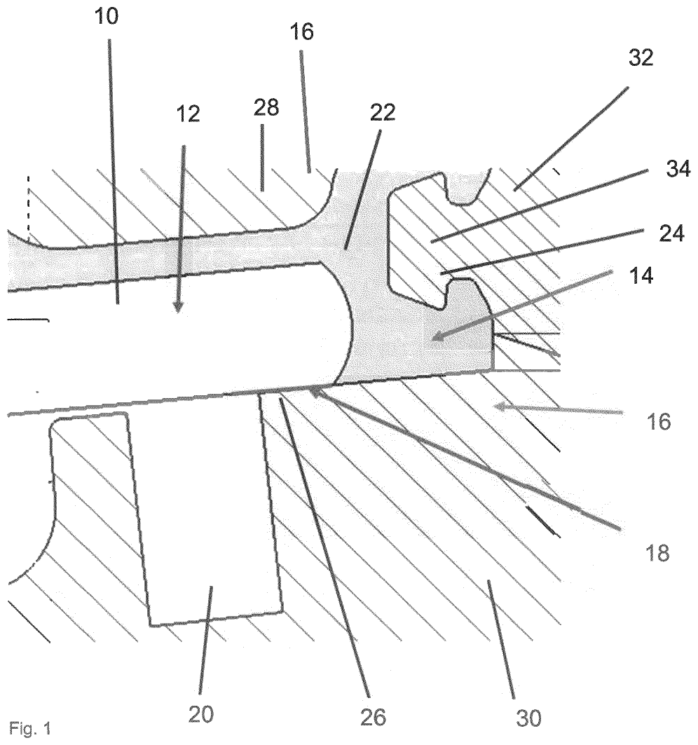

FIG. 1 shows a transparent sheet 12 of a cover 10 in a mold 16 which serves to overmold the transparent sheet 12 with a foam edging 14. For this purpose, the mold 16, shown in a cross-sectional view, has an upper portion of the mold 28, a lower portion of the mold 30 and an optional lateral portion of the mold 32, which together with the transparent sheet 12 form a cavity 22 for forming the foam edging 14. In the course of the method, a polymer foam is injected into the cavity 22 to form the foam edging 14.

The lateral portion of the mold 32 has a projection 34 that extends in horizontal direction outward into the cavity 22 and hence forms a groove 24 in the edge foaming 14, which serves for later mounting of a seal on the cover 10. Such a seal is provided in order to achieve a sealing effect between the cover 10 and an edge of the opening on closure of an opening in a vehicle roof by the cover 10. For this purpose, the groove 24 is T- or mushroom-shaped, such that a base of the seal is secured against becoming parted from the groove 24. The providing of a lateral portion of the mold 32 enables the forming of foam edging 14 with such an undercut. It may firstly be the case that the lateral portion of the mold 32 is designed as a slider and can be pushed out along the groove 24 after the foaming process. Secondly, it is also possible that forced demolding is envisaged, which means that the foam edging 14 is parted from the lateral portion of the mold 32 under elastic deformation. A groove 20 for accommodating a seal is provided on the lower portion of the mold 30.

In the method of the invention, in particular, a coating 18 is provided, which covers into a region 26 to be covered on the transparent sheet 12. The coating 18 consists of a self-adhesive polyester adhesive tape. The region 26 to be covered adjoins the cavity 22 and is also disposed on a side of the transparent sheet 12 which, in the installed state of the cover 10 on a vehicle roof, forms a top side of the cover 10. It should be noted here that the cover 10 in the mold 16 is aligned horizontally, just as it is subsequently in the installed state on the vehicle roof, but rotated by 180°, i.e. with the top side of the cover downward, as shown in FIG. 1. Since the coating 18 is disposed in the region 26 to be covered on the transparent sheet 12, and the transparent sheet 12 has already been provided with said coating 18 before being introduced into the mold 16, the transparent sheet 12 thus lies on the mold 16, specifically on the lower portion of the mold 30, by the coating 18 after being introduced into the mold 16 and before the mold 16 is closed.

In order to close the mold 16, the upper portion of the mold 28 is lowered onto the transparent sheet 12. The transparent sheet 12 is pressed against the lower portion of the mold 30, with compression of the coating 18 between the upper portion of the mold 28 and lower portion of the mold 30 in the region 26 to be covered, and hence a good sealing effect can be developed.

Since the region 26 to be covered and the coating 18 therewith directly adjoin the cavity 22, the sealing effect thus takes place between the lower portion of the mold 30 and the transparent sheet 12 with respect to the cavity 22 as well. The coating 18 is consequently arranged such that it reliably prevents the escape of foam material from the cavity 22 onto the top face of the transparent sheet 12 (which is understood to mean the top face in the installed state of the cover 10).

In order to optimize the sealing effect, the coating 18 is formed from the polyester material, which is particularly elastic compared to the transparent sheet 12 and the lower portion of the mold 30. The coating 18 is bonded to the region 26 to be covered before the transparent sheet 12 is inserted into the mold 16. The coating 18 forms an elastic film that ensures the above-elucidated sealing effect. This achieves the effect that, compared to known methods without such a coating 18, the cavity 22 is significantly better sealed. In particular, this achieves the effect that the gap formed at the join between the inserted transparent sheet 12 and the lower portion of the mold 30 is sufficiently well sealed that no foam material can get into the region 26 to be covered in the foaming process. By comparison with known methods that do not provide for such a coating 18, it is thus possible to dispense with laborious cleaning methods.

Once the transparent sheet 12 has thus been provided with the foam edging 14, it is removed from the mold 16, but still has the coating 18 on the region 26 to be covered. However, this coating 18, by virtue of an appropriate selection of material, is easy to part from the cover 10, for example by pulling it off. For this purpose, the material for the coating 18 is chosen such that, firstly, the sealing effect in the mold 16 is optimized and, secondly, simple detachment is also achieved.

When a correspondingly elastic material is provided for the coating 18, it is thus possible to simply pull the coating 18 away from the surface of the transparent sheet in the next step. There is therefore no longer any need for complicated mechanical reworking or cleaning operations in the method of the invention. A considerable cost benefit is thus generated, and a distinct improvement in quality is achieved. A particularly preferred feature has been found here to be a polyester adhesive tape for the coating 18, which firstly optimizes the sealing effect and secondly enables easy parting of the coating 18 from the transparent sheet 12 without leaving residues or soiling on the transparent sheet 12.

### LIST OF REFERENCE NUMERALS

10 cover
12 transparent sheet
14 foam edging
16 mold
18 coating
20 groove for seal
22 cavity
24 groove
26 region to be covered
28 upper portion of mold
30 lower portion of mold
32 lateral portion of mold
34 projection

1. A method of producing a cover for elective opening or firm closing of an opening in a vehicle roof, wherein the cover has a transparent sheet and a foam edging, comprising
applying a coating atop a region to be covered on the transparent sheet that is to be visible at a later stage, adjacent to the foam edging to be foamed,
introducing the transparent sheet into an open mold such that an edge region of the sheet is disposed in a cavity of the mold for formation of foam edging on the sheet,
closing the mold,
injecting a polymer or polymer foam into the cavity to form the foam edging of the cover,
opening the mold and removing the cover from the mold, and
then removing the coating.

2. The method as claimed in claim 1, wherein the coating forms a sealing section.

3. The method as claimed in claim 2, wherein the coating, with the mold closed, seals a lower portion of the mold against the transparent sheet.

4. The method as claimed in claim 3, wherein the coating, with the mold closed, seals the lower portion of the mold and the transparent sheet with respect to the cavity.

5. The method as claimed in claim 1, wherein the transparent sheet is a glass sheet.

6. The method as claimed in claim 1, wherein the foam edging is formed from a polyurethane foam.

7. The method as claimed in claim 1, wherein the coating is applied by applying a liquid polymer to the region to be covered before the transparent sheet is introduced into the mold.

8. The method as claimed in claim 7, wherein the liquid polymer on the region to be covered is solidified before the transparent sheet is introduced into the mold.

9. The method as claimed in claim 1, wherein the coating is applied by applying a solid film onto the region to be covered before the transparent sheet is introduced into the mold.

10. The method as claimed in claim 1 wherein an elastic material is used for the coating.

11. The method as claimed in claim 1, wherein the mold has an upper portion of the mold, a lower portion of the mold and a lateral portion of the mold, which bound the cavity, and there is a projection disposed on the lateral portion of the mold that forms a groove in the foam edging for mounting of a seal on the cover.

12. The method as claimed in claim 1, wherein the coating is disposed on one side of the transparent sheet which, in the installed state of the cover on a vehicle roof, constitutes a top face of the cover.

13. The method as claimed in claim 12, wherein the foam edging extends from an outer edge of the transparent sheet as far as an opposite side of the transparent sheet from the coating.

14. The method as claimed in claim 9, wherein applying the coating is by sticking a polymer film onto the region to be covered before the transparent sheet is introduced into the mold.

15. The method as claimed in claim 10, wherein the elastic material used for the coating is a polyester adhesive tape.
